(19) United States
(12) Patent Application Publication
(10) Pub. No.: US 2011/0173922 A1
(43) Pub. Date: Jul. 21, 2011

(54) TRIM KIT FOR BUILDING CONSTRUCTION

(75) Inventor: Wayne J. Buoni, New Albany, OH (US)

(73) Assignee: Boral Stone Products LLC

(21) Appl. No.: 13/008,504

(22) Filed: Jan. 18, 2011

Related U.S. Application Data
(60) Provisional application No. 61/295,868, filed on Jan. 18, 2010.

(51) Int. Cl. E06B 1/34; E04C 2/38

(52) U.S. Cl. 52/717.01; 52/745.15

(57) ABSTRACT

A trim kit for trimming an opening such as a door or window opening in a building structure or the like is provided. The trim kit comprises a starter strip including a securing leg, a trim panel abutment flange and a first groove and a trim panel including a pre-cast body. The pre-cast body includes at least one decorative element, a tongue, a projecting nose and a channel between the tongue and projecting nose. When installed the tongue of the trim panel is received in the first groove of the starter strip and the abutment flange of the starter strip is received in the channel of the trim panel with the projecting nose overlying the abutment flange.

### CROSS REFERENCE TO RELATED APPLICATIONS

This application claims the benefit of pending U.S. Provisional Patent Application No. 61/295,868, filed Jan. 18, 2010, the disclosure of which is incorporated herein by reference.

### BACKGROUND OF THE INVENTION

The present invention relates generally to the construction field and, more particularly, to a prefabricated trim panel kit incorporating a starter strip and a trim panel.

Prefabricated or cast veneer wall panels have been developed as a quick and efficient way to provide a masonry appearance for a building while simplifying construction and lowering construction cost. The design elements of prefabricated wall panels typically simulate brick, stone, tile and other masonry building components or materials commonly used in the construction of buildings. Examples of prefabricated wall panels are disclosed in U.S. Pat. No. 3,142,938 to Eberhardt, U.S. Pat. No. 4,669,238 to Kellis et al, U.S. Pat. No. 5,379,561 to Saito, and U.S. Pat. No. 5,673,529 to Treister et al., in published U.S. Patent Application Pub. No. 2007/0137128 to Viau et al., and in co-pending Patent Application Serial No. 11/647,751 owned by the Assignee of the present invention.

Prefabricated wall panels are typically made from reinforced construction materials such as fiberglass reinforced concrete. Prefabricated wall panels made from such reinforced materials are resistant to damage to handling during packaging, shipping and installation.

The present invention relates to a trim kit and related method for quickly and conveniently installing “masonry” trim around building openings such as windows and doors.

### SUMMARY OF THE INVENTION

In accordance with the purposes of the present invention as described herein, a trim kit is provided for trimming an opening such as a door or window opening in a building structure or the like. The trim kit comprises (a) a starter strip comprising a securing leg, a trim panel abutment flange and an upwardly directed channel; and (b) a trim panel comprising a pre-cast body having at least one decorative element, a tongue, a projecting nose and a downwardly directed channel between the tongue and projecting nose. When installed the tongue of the trim panel is received in the upwardly directed channel of the starter strip and the abutment flange of the starter strip is received in the downwardly directed channel of the trim panel, with the projecting nose overlying the abutment flange.

In accordance with an additional aspect of the present invention, a trim kit is provided for trimming an opening such as a door or window opening in a building structure or the like. The trim kit comprises (a) a starter strip comprising a trim panel abutment flange and an upwardly directed channel; and (b) a trim panel comprising a tongue, a projecting nose, and a downwardly directed channel between the tongue and projecting nose. The upwardly directed channel includes a plurality of walls that collectively define a first groove, and the downwardly directed channel similarly defines a second groove. When installed the tongue of the trim panel is received in the first groove and the abutment flange is received in the second groove, with the projecting nose overlying the abutment flange.

In accordance with an additional aspect of the present invention, a method of trimming an opening in a building structure is provided. The method comprises the steps of aligning a starter strip along an edge of the opening, securing the starter strip in position and positioning a trim panel in a proper registration position on the starter strip. More specifically, the method includes using (a) a starter strip including a securing leg, a trim panel abutment flange and a groove and (b) a trim panel including a pre-cast body having at least one decorative element, a tongue, a projecting nose, and a channel between the tongue and projecting nose.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is an exploded perspective view of the trim kit of the present invention;

FIG. 2a is a detailed front elevational view of the starter strip;

FIG. 2b is a detailed end elevational view of the starter strip;

FIG. 3 is a cross sectional view illustrating the trim kit mounted to the sheathing of a building;

FIG. 4 is a front elevational view illustrating starter strips mounted around a door opening of a structure; and

FIG. 5 is a front elevational view like FIG. 4 showing the mounting of two trim panels to the starter strips.

Reference will now be made in detail to the present preferred embodiment of the invention, examples of which are illustrated in the accompanying drawings.

### DETAILED DESCRIPTION OF VARIOUS EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

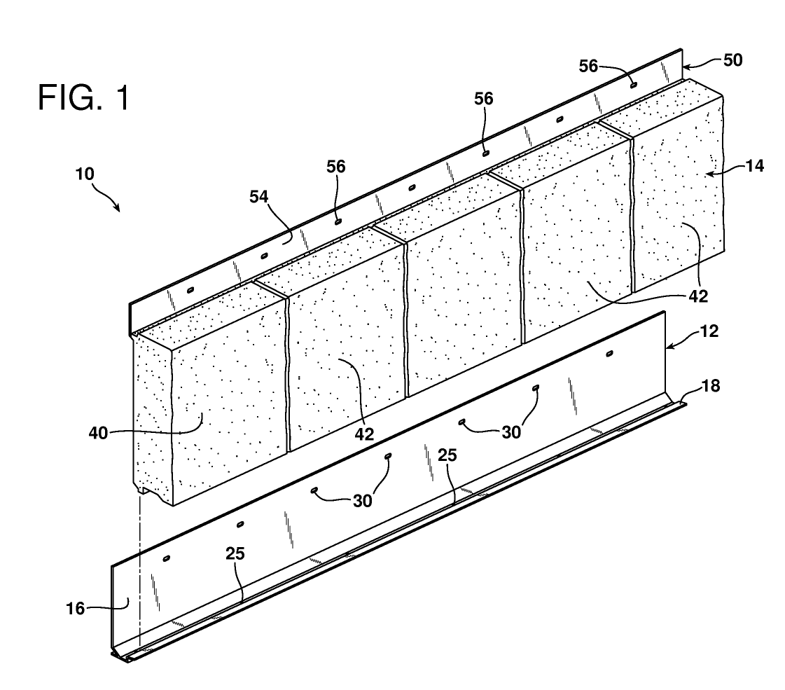

Reference is now made to FIG. 1 illustrating the trim kit 10 of the present invention including the starter strip 12 and the cooperating trim panel 14. As will be appreciated from the following description, the trim kit 10 of the present invention allows one to quickly and easily provide “masonry” trim around any opening such as a window or door opening in any type of structure.

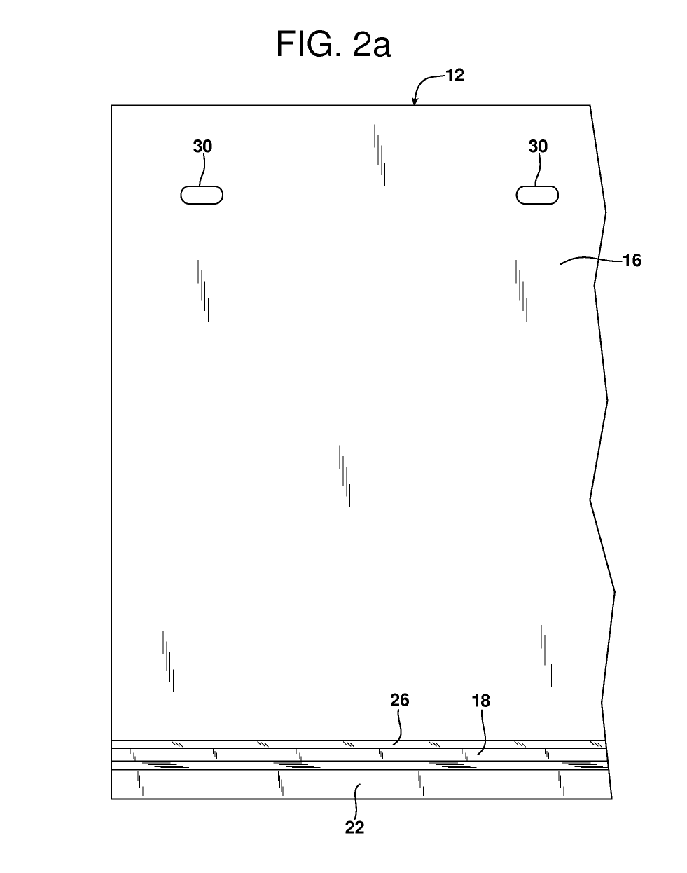

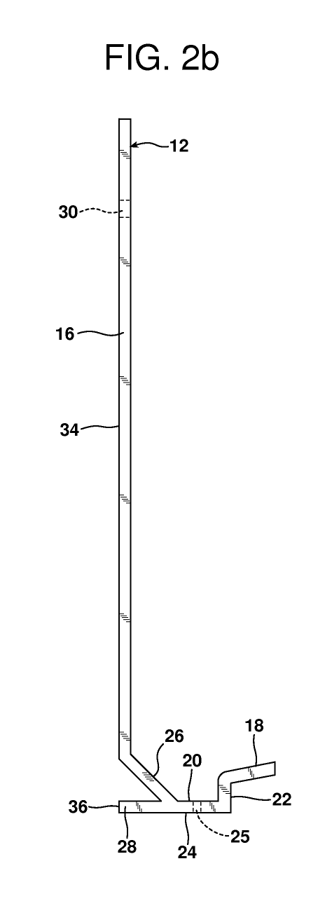

As best illustrated in FIGS. 2a and 2b, the starter strip 12 includes a securing leg 16, an abutment flange 18 and a first upwardly directed channel that forms a first groove 20. In various embodiments, the groove 20 is formed by a front wall 22, a bottom wall 24 and a rear wall 26 of the first upwardly directed channel. As illustrated, the front wall 22 in certain embodiments is connected to the abutment flange 18 and the rear wall 26 is formed by an angled leg connected to the securing leg 16. In certain embodiments, one or more weep holes 25 are provided in the bottom wall 24 of the groove 20 formed by the upwardly directed channel in order to drain moisture away from the sheathing of a building. As further illustrated, the starter strip 12 according to certain embodiments includes a stabilizing leg 28 that projects from the bottom wall 24 at the point where the bottom wall and the rear wall/angled leg 26 meet.

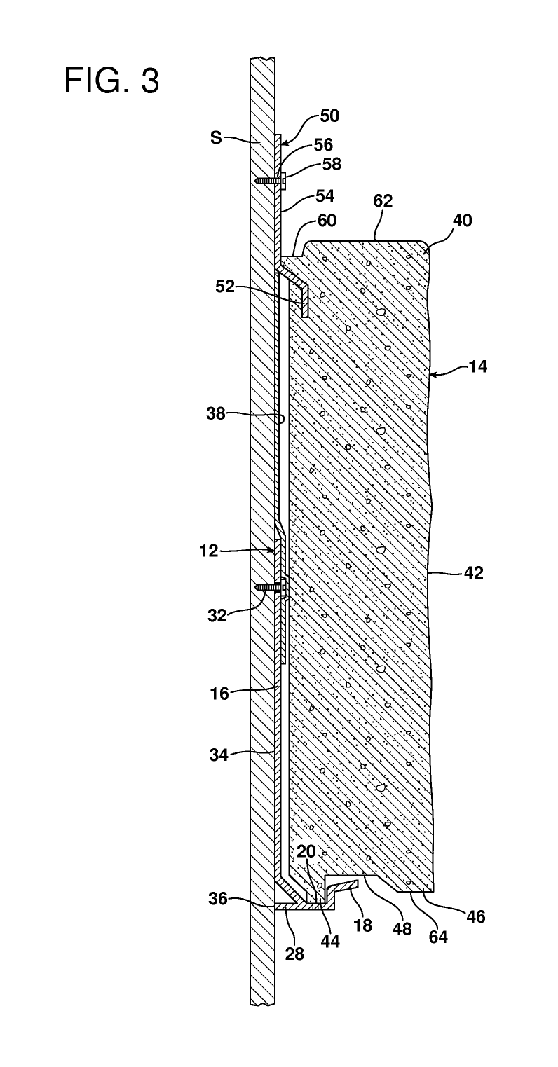

The starter strip 12 is mounted to the sheathing or frame work of a building by means of the securing leg 16. As illustrated in FIG. 3, the rear face 34 of the securing leg 16 and the distal end 36 of the stabilizing leg 28 are aligned in a single plane. The rear face 34 and distal end 36 are placed flush against the sheathing S or adjacent any intervening water resistive barrier (WRB) material 38 and anchored in position. More specifically, the starter strip 12 is aligned and positioned as desired and a series of fasteners 32, such as nails or screws, are positioned in spaced apertures 30 along the securing leg 16 to hold the starter strip 12 securely in place.

The starter strip 12 may be made from any suitable material including, but not limited to, concrete, cellulose fiber board, polymer material, composite material, metal, plastic, reinforced plastic, thermoplastic, fiber composite, steel, corrosion-resistant steel, aluminum, stainless steel, zinc, copper and combinations thereof. The corrosion-resistant steel may take any number of forms including, but not limited to, galvanized, galvanneal, Gavalume™ brand, tin coated, chromium coated, nickel coated, phosphorous coated, magnesium coated, copper coated, zinc coated, weathered steels (i.e., alloys of steel with small additions of copper, aluminum, nickel and/or phosphorous), polymer coated and painted.

Polymer materials useful for the making of the starter strip 12 include various thermoplastic and thermoset resins including but not limited to polyolefins, polyesters, polyvinylchloride, polypropylene, polyethylene, polyamide, epoxy, vinyl ester, acrylic, polystyrene, ABS, melamine and mixtures thereof. Composite materials used to make the starter strip 12 may include a reinforcing material and a matrix binder. Appropriate reinforcing materials useful in the present invention include but are not limited to glass fibers, natural fibers, mineral fibers, basalt fibers, carbon fibers, kenaf fibers, jute fibers, hemp fibers, E-glass fibers, C-glass fibers, R-glass fibers, S-glass fibers, ECR-glass fibers, AR-glass fibers and mixtures thereof. It should be appreciated that substantially any type of glass fiber may be used for reinforcement fibers. Glass fibers appropriate for use in the present invention may be loose chopped strand or glass mat and include those available under the trademark ADVANTEX. Matrix binder materials useful for this purpose include but are not limited to polyolefins, polyesters, polyvinylchloride, polypropylene, polyethylene, polyamide, epoxy, vinyl ester and mixtures thereof.

In various embodiments, the trim panel 14 includes a pre-cast body 40 having at least one, and more typically, a series of decorative elements 42. The decorative elements 42 may take substantially any desired form including one or more rows of bricks, stones or the like. It should be appreciated that substantially any masonry material known in the art may be simulated including bricks of different sizes, stones of the same or different sizes or shapes, tiles of different sizes and shapes and the like. The pre-cast body 40 is made from a cast material such as concrete, reinforced concrete, gypsum, fiber reinforced gypsum, polymer-modified gypsum, reinforced cementitious material and mixtures thereof. Typically the cast material reinforcement comprises fibers selected from a group of materials consisting of glass fibers, carbon fibers, mineral fibers, natural fibers, polymer fibers and mixtures thereof. Where glass fibers are used they may be of the E-glass or AR-glass type which exhibits some alkali resistance.

As further illustrated in FIG. 3, the trim panel according to various embodiments includes a tongue 44, a projecting nose 46 and a downwardly directed channel 48 formed in the pre-cast body 40. As illustrated, the downwardly directed channel 48 is provided between the tongue 44 and the projecting nose 46.

A mounting strip 50 includes a first end 52 that is embedded in the pre-cast body 40 and a second end 54 that projects from the pre-cast body. This may be accomplished by positioning the mounting strip 50 so that the first end 52 projects into the mold cavity in which the pre-cast body 40 is cast. After positioning the mounting strip 50, the cast material is gravity fed, sprayed, injected or otherwise added to the mold. The cast material of the body 40 covers the front and rear faces of the first end 52 of the mounting strip 50. When set, the body 40 securely holds or keys the mounting strip 50 in position. In some embodiments, the first end 52 includes a series of spaced keying holes that fill with the cast material and ensure that the mounting strip is firmly seated and secured in the cast body 40 once the material sets.

As should be appreciated from reviewing FIGS. 1 and 3, the second end 54 of the mounting strip 50 includes a series of spaced apertures 56. Fasteners 58, such as nails or screws are provided in these apertures 56 to secure the trim panel 14 to the underlying sheathing S during installation. Alternatively, a nail may simply be driven through the relatively thin strip 50 and the apertures 56 need not be provided.

A second groove 60 is formed by the mounting strip 50 and pre-cast body 40 at a first edge 62 of the pre-cast body 40 opposite the second edge 64 which includes the tongue 44, the projecting nose 46, and the intermediate, downwardly directed channel 48. When constructing the façade of a building, the second groove 60 functions to receive the tongue 44 of the next prefabricated wall panel mounted to the sheathing S in an abutting position to the trim panel 14.

In one particularly useful embodiment the first groove 20 of the starter strip 12 and the second groove 60 of the trim panel 14 have a depth of between about 0.1875 and about 0.3125 inches and a width of between about 0.25 and about 0.375 inches. The abutment flange 18 has a length of between about 0.4 and about 0.425 inches and the downwardly directed channel 48 has a depth of between about 0.1875 and about 0.25 inches and a width of between about 0.5 and about 0.75 inches.

In various embodiments, the projecting nose 46 projects from the bottom of the downwardly directed channel 48 sufficiently to hide the abutment flange 18 of the starter strip 12. More specifically, it should be appreciated that in certain embodiments the tongue 44 engages in the groove 20 of the starter strip 12 to hold the trim panel 14 in place with the nose 46 of the panel adjacent to, but not butting against, the window or door frame. Thus, the registration of the trim panel 14 in proper position around a window or door frame is insured by the interference fit provided by the tongue 46 and groove 20. In this manner, according to certain embodiments, the downwardly directed channel 48 simply functions to hide the abutment flange 18 from view.

As should be appreciated from reviewing FIG. 3, when the trim panel 14 is properly seated and connected with the starter strip 12, the tongue 44 is received in the first groove 20 formed by the upwardly directed channel, while the abutment flange 18 is received in the downwardly directed channel 48. Simultaneously, the projecting nose 46 overlies the abutment flange 18, thereby hiding it from view so as to provide an aesthetically pleasing appearance.

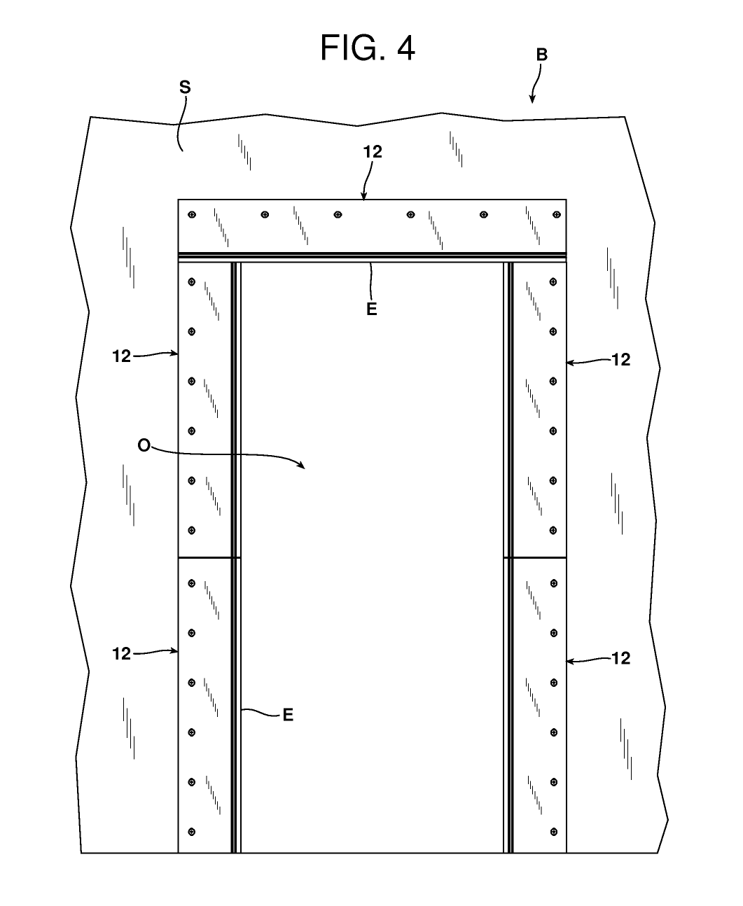

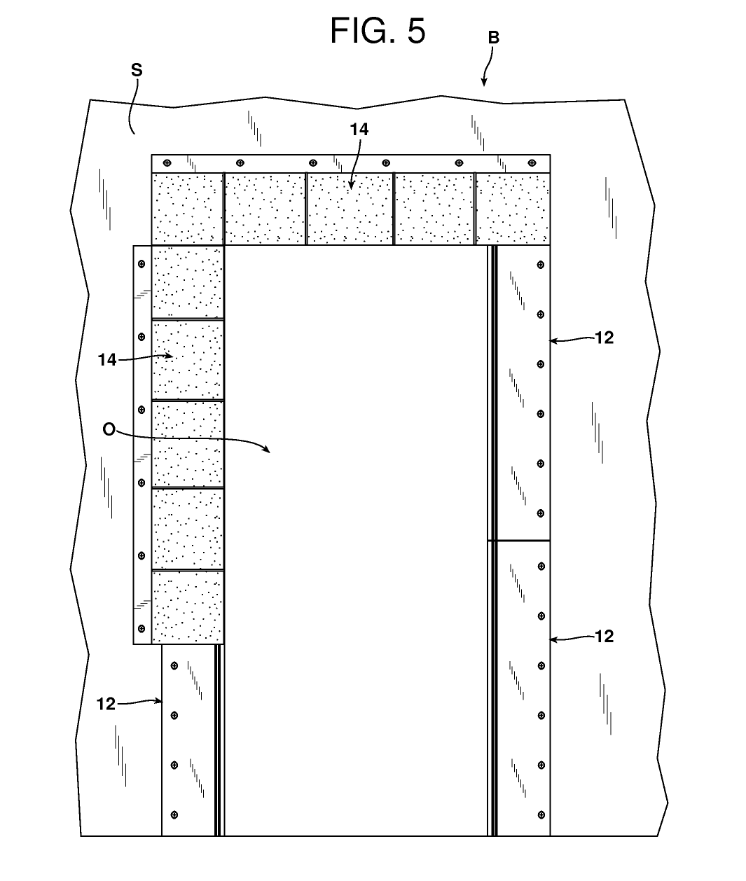

The method of trimming an opening, such as a door or window opening, in a building or other structure will now be described in detail with reference to FIGS. 4 and 5. The first step of the method provides for the aligning of a starter strip 12 along an edge E of an opening O, such as the door opening shown in the building B. Next is the securing of the starter strip 14 in position. This is done with the groove 20 adjacent the edge E of the opening O and the groove formed by the upwardly directed channel opening away from the opening O in the building B. As illustrated in FIG. 4, one elongated starter strip 12 extends along the top of the doorway opening O while additional starter strips 12 are provided along the sides of the opening. As illustrated, the starter strip 12 along the top of the opening O laps the starter strips along the sides of the opening. As should be appreciated from the above description, all of the starter strips 12 are secured in proper position utilizing fasteners 32 positioned in the apertures 30 along the securing leg 16 of each starter strip 12.

Next is the positioning of a trim panel 14 in a proper registration position on a starter strip 12. As best illustrated in FIG. 5, an elongated trim panel 14 is shown positioned along the top of the opening O. Specifically, the tongue 44 of the trim panel 14 is inserted into the upwardly directed channel, and in particular into the groove 20 of the starter strip 12 while the abutment flange 18 is received in the downwardly directed channel 48. When properly positioned and aligned on the starter strip 12 according to various embodiments, the trim panel 14 is secured in position by means of fasteners 58 secured in the apertures 56 of the mounting strip 50. The fasteners 58 engage the underlying sheathing S of the building B to provide a secure connection.

As further illustrated in FIG. 5, according to various embodiments, the trim piece is similarly positioned in the starter strips 12 along the sides of the opening O. Specifically, the tongue 44 of the trim panel 14 is positioned in the first groove 20 of the starter strip 12 while the abutment flange 18 is received in the channel 48 behind the projecting nose 46. The trim panel 14 is held in proper position until fasteners 58 are secured into the underlying sheathing through the apertures 56 in the mounting strip 50 to complete the connection. For ease of installation, it is generally easier to start at the bottom of the side of the opening O and work upward toward the trim panel 14 extending across the top of the opening O. Here it should be appreciated that a starter strip 12 and/or trim panel 14 may need to be cut to length to fit any particular application and size of opening O.

The foregoing description of the various embodiments of the present invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. A trim kit for trimming an opening in a building structure, said trim kit comprising:
a starter strip comprising a securing leg, a trim panel abutment flange, and an upwardly directed channel; and
a trim panel comprising a pre-cast body having at least one decorative element, a tongue, a projecting nose, and a downwardly directed channel, wherein:
said downwardly directed channel is located substantially between said tongue and said projecting nose of said trim panel; and
said tongue of said trim panel is substantially received in said upwardly directed channel of said starter strip and said abutment flange of said starter strip is substantially received in said downwardly directed channel of said trim panel such that said projecting nose substantially overlies said abutment flange when said starter strip and trim panel are positioned adjacent one another.

2. The trim kit of claim 1, wherein:
said upwardly directed channel comprises a front wall, a bottom wall and a rear wall;
said front wall is connected to said abutment flange;
said rear wall is connected to said securing leg; and
said front wall, said bottom wall, and said rear wall define a first groove.

3. The trim kit of claim 2, wherein said rear wall is defined by an angled leg extending between said bottom wall and said securing leg.

4. The trim kit of claim 3, further including a stabilizing leg projecting from said bottom wall at a point where said bottom wall and said angled leg meet.

5. The trim kit of claim 4, wherein a rear face of said securing leg and a distal end of said stabilizing leg are aligned in a single plane.

6. The trim kit of claim 1, wherein said trim panel further includes a mounting strip.

7. The trim kit of claim 6, wherein said mounting strip has a first end embedded in and keyed to said pre-cast body, and a second end projecting from said pre-cast body.

8. The trim kit of claim 7, wherein said mounting strip and a portion of said pre-cast body form a second groove.

9. The trim kit of claim 8, wherein said tongue is formed along a first edge of said trim panel and said second groove is formed along a second, opposite edge of said trim panel.

10. The trim kit of claim 1, wherein said upwardly directed channel and said downwardly directed channel each have a depth of between about 0.1875 and about 0.3125 inches and a width of between about 0.25 and about 0.375 inches.

11. The trim kit of claim 10, wherein said abutment flange has a length of between about 0.4 and about 0.425 inches, said upwardly directed channel has a depth of between about 0.1875 and about 0.25 inches and a width of between about 0.5 and about 0.75 inches, and said projecting nose projects sufficiently to substantially hide said abutment flange from view.

12. The trim kit of claim 1, wherein the at least one decorative element includes a plurality of decorative pieces configured to create an appearance of a plurality of stone tiles.

13. A trim kit for trimming an opening in a building structure, said trim kit comprising:
a starter strip comprising a trim panel abutment flange and an upwardly directed channel; and
a trim panel comprising a tongue, a projecting nose, and a downwardly directed channel, wherein:
said upwardly directed channel comprises a front wall, a bottom wall, and a rear wall that collectively define a first groove;
said downwardly directed channel defines a second groove, said second groove being located substantially between said tongue and said projecting nose of said trim panel; and
said tongue of said trim panel is substantially received in said first groove and said abutment flange is substantially received in said second groove such that said projecting nose substantially overlies said abutment flange when said starter strip and trim panel are positioned adjacent one another.

14. A method of trimming an opening in a building structure, comprising:
aligning a starter strip along an edge of said opening;
securing said starter strip in position;
positioning a trim panel in a proper registration position on said starter strip.

15. The method of claim 14, further comprising the use of (a) a starter strip comprising a securing leg, a trim panel abutment flange and an upwardly directed channel; and (b) a trim panel comprising a pre-cast body having at least one decorative element, a tongue, a projecting nose and a downwardly directed channel, said downwardly directed channel being located substantially between said tongue and projecting nose.

16. The method of claim 15, wherein said securing step comprises securing said starter strip in position with said upwardly directed channel adjacent the edge of the opening and said upwardly directed channel facing away from said opening in the building structure.

17. The method of claim 16, wherein said positioning step further comprises:
inserting said tongue of said trim panel in said upwardly directed channel of said starter strip; and
inserting said abutment flange of said starter strip into said channel of said trim panel.

18. The method of claim 17, wherein said positioning step further comprises hiding said abutment flange and groove of said starter strip behind said projecting nose of said trim panel.
